(19) United States
(12) Patent Application Publication
(10) Pub. No.: US 2013/0132233 A1
(43) Pub. Date: May 23, 2013

(54) SUSTAINABILITY BASED SUPPLIER EVALUATION

(71) Applicants: Martina Rothley, Schwetzingen (DE); Johann Kemmer, Muehlhausen (DE)

(72) Inventors: Martina Rothley, Schwetzingen (DE); Johann Kemmer, Muehlhausen (DE)

(21) Appl. No.: 13/301,807

(22) Filed: Nov. 22, 2011

(51) Int. Cl. G06Q 30/00

(52) U.S. Cl. 705/26.35

(57) ABSTRACT

Various embodiments of systems and methods for evaluating suppliers and performing green sourcing analysis based on customized sustainability metrics are described herein. The method in an integrated information management system involves configuring one or more criteria relating to a product as green sourcing metrics. The method further includes defining one or more constraints effecting interdependencies between the green sourcing metrics. In a further aspect, the method includes determining that the one or more constraints is fulfilled based on product data relating to one or more suppliers supplying the product and customizing the green sourcing metrics based on the one or more constraints that is fulfilled. In yet another aspect, the method involves performing green sourcing analysis for the one or more suppliers of the product based on the customized green sourcing metrics. Based on the green sourcing analysis, the one or more suppliers are evaluated and a sourcing recommendation is provided based on the evaluation.

### FIELD

The field relates generally to carbon footprint management in product sourcing, and more specifically, the field relates to supplier evaluation based on customized sustainability metrics.

### BACKGROUND

Environmental conservation is a business imperative in today's world, as consumers and governments show increased interest in companies operating in ways that protect the environment. As a consequence, companies are looking to develop methods and tools to improve profitability while building their green credentials. Supply chains in general and green sourcing in particular are becoming one of the primary focal points to support these efforts.

Traditional sustainability measures are limited to inbound logistic operations, waste reduction opportunities, emission compliance, and choice of energy efficient products. However, such traditional measures fail to consider external green efforts such as identifying and working with green suppliers for sourcing parts and products. For example, a company may monitor and control its internal processes and systems to align with sustainable practices, but may lack a system and process to monitor and evaluate the sustainability measures taken by its suppliers or partners. Also, in some instances, organizations evaluate the environmental impact of supply chain operations based on a standardized set of metrics which are designed without considering the impact of factors that effect tradeoffs between different variables underlying the metrics. Such evaluations based on a standardized set of metrics produce inaccurate and inconsistent results.

### SUMMARY

Various embodiments of systems and methods for evaluating suppliers and performing green sourcing analysis based on customized sustainability metrics are described herein. A method for performing green sourcing analysis in an integrated information management system involves configuring one or more criteria relating to a product and the product source as green sourcing metrics. The method further includes defining one or more constraints effecting interdependencies between the green sourcing metrics. In a further aspect, the method includes determining that the one or more constraints is fulfilled based on product data relating to one or more suppliers supplying the product and customizing the green sourcing metrics based on the one or more constraints that is fulfilled. In yet another aspect, the method involves performing green sourcing analysis for the one or more suppliers of the product based on the customized green sourcing metrics. Based on the green sourcing analysis, the one or more suppliers are evaluated and a sourcing recommendation is provided. In another aspect, based on the green sourcing analysis, a supplier development plan is proposed to the one or more suppliers to improve the one or more suppliers' green score.

These and other benefits and features of embodiments of the invention will be apparent upon consideration of the following detailed description of preferred embodiments thereof, presented in connection with the following drawings.

### BRIEF DESCRIPTION OF THE DRAWINGS

The claims set forth the embodiments of the invention with particularity. The invention is illustrated by way of example and not by way of limitation in the figures of the accompanying drawings in which like references indicate similar elements. The embodiments of the invention, together with its advantages, may be best understood from the following detailed description taken in conjunction with the accompanying drawings.

FIG. 1 is a flow diagram of a method for performing green sourcing analysis for suppliers, according to one embodiment.

FIG. 2 is a block diagram of an exemplary system for performing green sourcing analysis for suppliers, according to one embodiment.

FIG. 3 illustrates an exemplary supplier evaluation tool for providing customized green sourcing metrics, in accordance with an embodiment

FIG. 4 illustrates a dashboard on a graphical user interface, showing results of green sourcing analysis, in accordance with an embodiment.

FIG. 5 is a block diagram of an exemplary computer system according to one embodiment.

### DETAILED DESCRIPTION

Embodiments of techniques for performing evaluating suppliers and performing green sourcing analysis based on customized sustainability metrics are described herein. In the following description, numerous specific details are set forth to provide a thorough understanding of embodiments of the invention. One skilled in the relevant art will recognize, however, that the invention can be practiced without one or more of the specific details, or with other methods, components, materials, etc. In other instances, well-known structures, materials, or operations are not shown or described in detail to avoid obscuring aspects of the invention.

Reference throughout this specification to “one embodiment”, “this embodiment” and similar phrases, means that a particular feature, structure, or characteristic described in connection with the embodiment is included in at least one embodiment of the present invention. Thus, the appearances of these phrases in various places throughout this specification are not necessarily all referring to the same embodiment. Furthermore, the particular features, structures, or characteristics may be combined in any suitable manner in one or more embodiments.

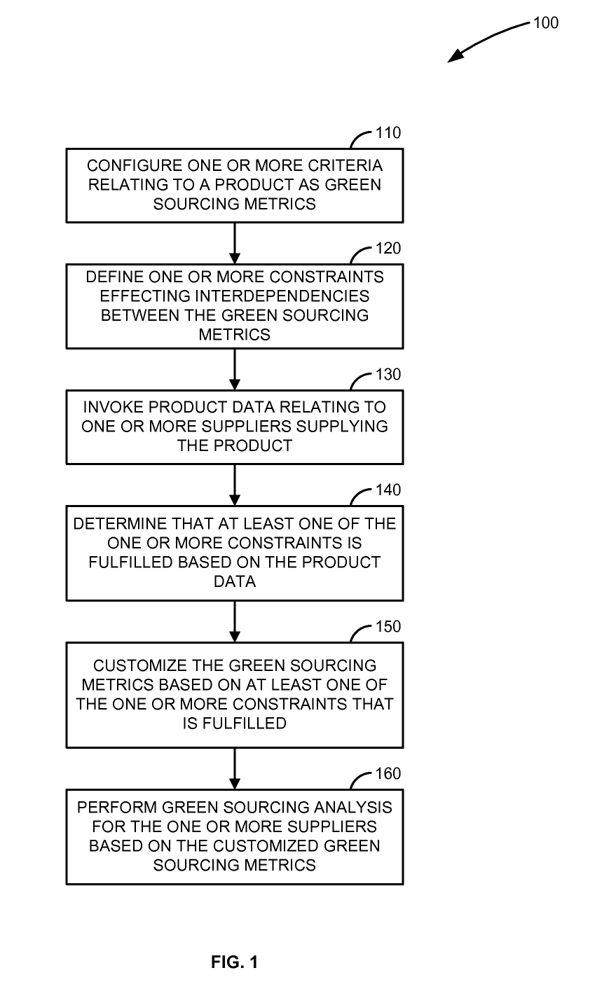

FIG. 1 illustrates a flow diagram of a method for performing green sourcing analysis for one or more suppliers, according to an embodiment. The method 100, implemented by a computer in an integrated information management system, includes configuring (110) one or more criteria relating to a product and/or the supplier of the product, as green sourcing metrics. As used herein, the term “green” relates to ecologically sustainable practices, measures, metrics, or characteristics. The term “metric” refers to related measures that facilitate the quantification of some particular characteristic. The one or more criteria, used to evaluate the sustainability score of a supplier, refer to material(s) used for manufacturing the product, design and functionality of the product, extraction and processing of materials, packaging and distribution, manufacturing processes, mode of transport, emission control measures, distance between a supplier site and a procurement site (of either purchaser or customer), energy management measures, waste disposal measures, environmental policies, and compliance certificates. Examples of the one or more criteria include low carbon emission manufacturing material, waste disposal measures, emission control measures, transport by railroad, recyclable packaging material, renewable energy source employed by the supplier, etc. In an embodiment, the integrated information management system is an Enterprise Resource Planning (ERP) system having a plurality of business modules which are integrated to each other over a communication network. Further, the ERP system is enabled with automated pull mechanisms allowing real-time processing and execution of inspection data. As used herein, the term “real-time” refers to a time frame that is brief, appearing to be immediate or near concurrent. When the computer processes data in real time, it reads and handles data as it is received, producing results without delay. The terms “commodity,” “goods,” and “product” will hereinafter be used interchangeably and refer to one and the same. The term “supplier” as used herein refers to a dealer, a manufacturer, a business partner, a contractor, or a seller dealing with the sourcing product.

Referring back to FIG. 1, the method 100 further includes defining (120) one or more constraints effecting interdependencies between the green sourcing metrics. Defining the one or more constraints refers to defining override conditions involving the interrelations between the one or more green sourcing metrics. Examples of the one or more constraints include conditions involving interrelations such as: distance Vs mode of transport, waste disposal measures Vs zero by-product manufacturing material, waste disposal measures Vs climatic conditions, packaging material Vs mode of transport, carbon emission control Vs low carbon emission manufacturing material, source of energy Vs Geographic location, packaging Vs climatic conditions of the region. In an example, an override condition involving a distance from source to destination and mode of transport may be defined as: <<For distance<X Kms, Transport by truck=Transport by rail, ship or air freight>>. In another example, an override condition involving mode of transport and packaging may be defined as: <<For transport by ship, water-proof packaging material=recycled paper packaging material>>.

In an embodiment, the one or more constraints are pre-configured according to a certain setting involving a particular product, supplier, or a geographic location. For example, for a supplier located in a particular geographic location, the green sourcing metrics can be customized based on the known distance from that geographic location, the climatic conditions of the region, the current/forecast weather, the feasible means of transport, the governing laws and standards for that geographic region, etc. Such information may be manually entered and stored in the computer or automatically received from data source systems in communication with the computer over an integrated network. Further, the pre-configured setting can be overridden by specific rules referring to e.g., a product (or product category) or a group of suppliers. Data source systems may include databases, such as, relational, transactional, hierarchical, multi-dimensional (e.g., OLAP), object oriented databases, and the like. Data source systems may also include a data source where the data is not tangibly stored or otherwise ephemeral such as data streams, broadcast data, and the like.

Further, the method includes invoking (130) a product data relating to one or more suppliers supplying the product. The term “product data” as used herein generally refers to information pertaining to the production and delivery of a particular commodity by a particular supplier. Example of product data include product related characteristics such as material(s) used for manufacturing the product, design and functionality of the product, extraction and processing of materials, packaging and distribution, manufacturing processes, mode of transport, emission control measures, distance between a supplier site and a procurement site, energy management measures, waste disposal measures, environmental policies, and compliance certificates. The product data for a supplier can be automatically extracted from supplier factsheets, product factsheets, supplier master records, product category factsheets, product master records, supplier invoices, contracts, surveys, questionnaires, integrated ERP systems, web services, and external data feeds. In an embodiment, the product data for a supplier is acquired through a questionnaire sent along with a Request for Quotation (RFQ), a Request for Bid (RFB), a Request for Information (RFI), or any other RFXs. In an example, a sample questionnaire sent along with an RFx for suppliers may include the following:
Do you have energy efficient production technology?
Do you have manufacturing facilities running on renewable energy? If so please identify.
What are your waste management strategies (i.e. recycling or landfill or composting)?
Do you have an Social and Environmental Corporate Responsibility Program?
Do you have an environmental management system (EMS)?
Do you consider environmental issues in the design process?
Do you provide any data on your company's environmental impacts?
Are any toxic materials in your manufacturing process? If so, please identify.
Do you incorporate any recycled material, particularly from post-consumer sources, in your production?
Are you Forest Stewardship Council (FSC) certified?
Are you Sustainable Forestry Initiative (SFI) certified?
Are you ISO 14001 certified?

Based on the product data extracted from one or more of the mentioned sources, it is determined (140) whether at least one of the one or more constraints is fulfilled for a particular supplier. If the one or more constraints are fulfilled, the green sourcing metrics for evaluating the supplier is customized (150) according to the one or more constraints that are fulfilled i.e., the green sourcing metrics are assigned an adjusted score, automatically by the system, according to the one or more constraints that are fulfilled. For example, if from the product data of a particular supplier it is determined that the travel distance from the source of origin of the goods to the destination is <15 Kms and that either of the origin and destination location faces a stormy or snowy weather, the green sourcing metrics are customized based on the pre-defined criteria involving distance Vs mode of transport and climatic conditions Vs packaging material. For this particular example scenario, the green sourcing metrics may be customized as follows:
Transport by truck <scores equal to> transport by rail or ship.
Waste disposal by combustion <scores equal to> waste disposal by recycling waste.
Packaging by water-proof material <scores equal to> packaging by recycled paper.

The pre-defined criteria are configured so as to enable consistent and optimal assessment of suppliers with varying demographics. Such customization of metrics helps avoid “one size fits all” type of evaluation which generally leads to inaccurate results. In the given example, although the mode of transport by rail or ship may take precedence, in terms of sustainability, due to lower social costs such as reduced fuel consumption and carbon emission, it only seems like a more viable and practical option to choose roadways over railways or ship for transporting goods for a distance of less than 15 Kms. However, while performing a comparative evaluation of more than one supplier based on a standard set of green sourcing metrics, such factors may go unaccounted in the final scorecard generated for each supplier. For example, a first supplier using waterways for transport may have a better score compared to a second supplier using roadways, although the second supplier transports goods for under a distance of 15 Kms. In order to overcome such inconsistencies in evaluating suppliers having varying demographics, pre-defined conditions are set and the green sourcing metrics for evaluating a supplier are customized specific to that supplier.

Based on the customized green sourcing metrics for each of the one or more suppliers, a sourcing analysis is performed (160) for the one or more suppliers. In an embodiment, performing the sourcing analysis includes scoring each of the one or more suppliers based on the customized green sourcing metrics and providing a ranked list of suppliers according to their respective individual and overall scores. In another embodiment, performing the sourcing analysis includes identifying one or more suppliers whose green scores falls under a pre-defined threshold limit, and automatically searching for sourcing alternatives in terms of sustainability. In yet another embodiment, performing the sourcing analysis includes calculating the cost associated with sourcing the goods from one or more green suppliers and providing a comparison of the cost associated with sourcing the goods from the supplier(s) currently working with. In yet another embodiment, performing the sourcing analysis includes providing a sourcing recommendation identifying one or more suppliers as alternate sourcing options. The sourcing analysis may also identify one or more suppliers that may need to improve or develop their sustainable practices.

In an embodiment, the one or more metrics are classified into different categories such that each of the product_related_characteristics (PRC) falling with a particular category is assigned a score in relation the other PRCs falling within the same category. For example, the one or more metrics may be classified into one of the following categories: Design & Functionality, Extraction & Processing of materials, Manufacturing Processes, Packaging & Distribution, Logistics, and Recycling & Disposal. A score is then assigned to each of the PRCs within a particular category. For example, each of the PRCs falling within the metric category of Packaging & Distribution, such as aluminum foil, recycled paper, cartons, corrugated boxes, plastic laminates, paper boards, plastic films, plastic crates, glass bottles, tin containers, bamboo baskets, wooden boxes, bubble wraps, blister packs, textile material, jute, etc., is assigned a score. In an embodiment, the score for each PRC is determined based on certain regulatory requirements or sustainable aspects such as reuse, recyclability, ease of disposal, contaminate emissions, carbon emissions, energy recovery, mass and volume, etc. Similarly, for PRCs falling under the metric category Recycling & Disposal, such as composting, reprocessing, incineration, landfilling, etc., a score is assigned based on the environmental impact caused by each of the disposal methods. The one or more suppliers are then evaluated based on the customized green sourcing metrics and their associated scores. In an embodiment, the green score for each of the suppliers is calculated as an aggregate of the scores of the customized green sourcing metrics for each supplier. In an aspect, the suppliers green scores that are archived over a period of time may be analyzed to track the green trend of a particular supplier. The green supplier evaluation process may be performed as a part of supplier lifecycle management, sustainability studies, certification program, compliance audits by an inspecting body, supplier development program, and regular scheduled intervals.

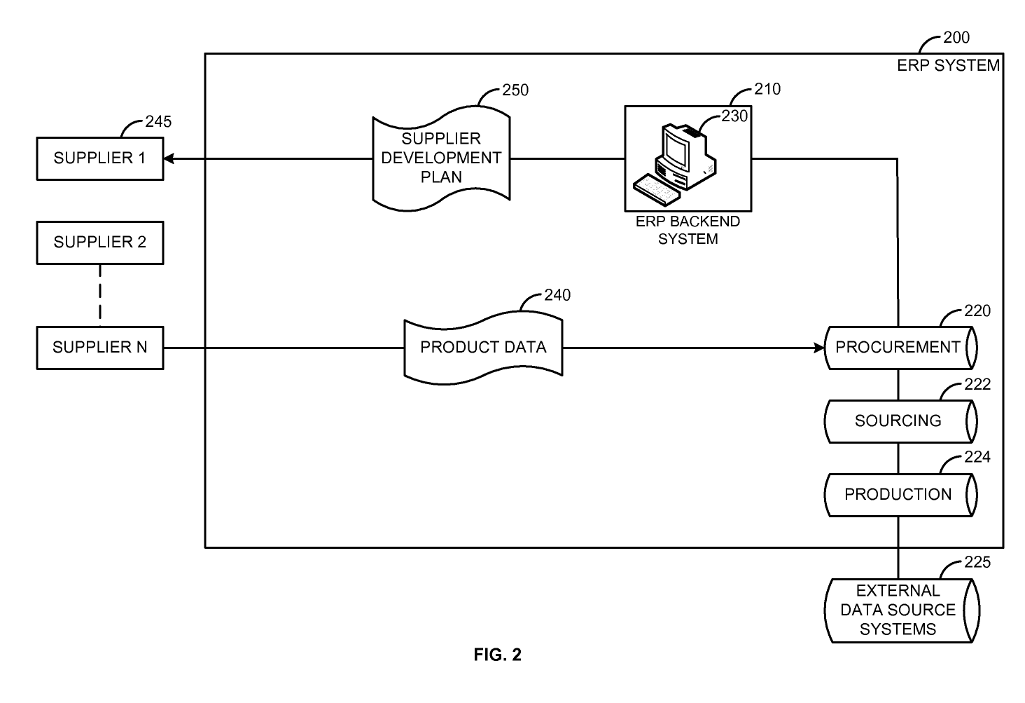

FIG. 2 illustrates a block diagram of an exemplary system for performing green sourcing analysis for suppliers, according to one embodiment. The system 200 includes a backend system 210, one or more business modules 220, 222, and 224, and external data source systems 225. In an embodiment, the system 200 is an ERP system integrated over a communication network. The ERP system 200 includes business modules relating to procurement 220, sourcing 222, and production 224. The ERP backend system 210 may include a computer 230 operating in communication with the business modules 220, 222, and 224, and external data source systems 225. Data source systems 225 include sources of data that enable data storage and retrieval. For example, data source systems 225 may include databases, such as, relational, transactional, hierarchical, multi-dimensional (e.g., OLAP), object oriented databases, and the like. Data source systems 225 may also include a data source where the data is not tangibly stored or otherwise ephemeral such as data streams, broadcast data, and the like.

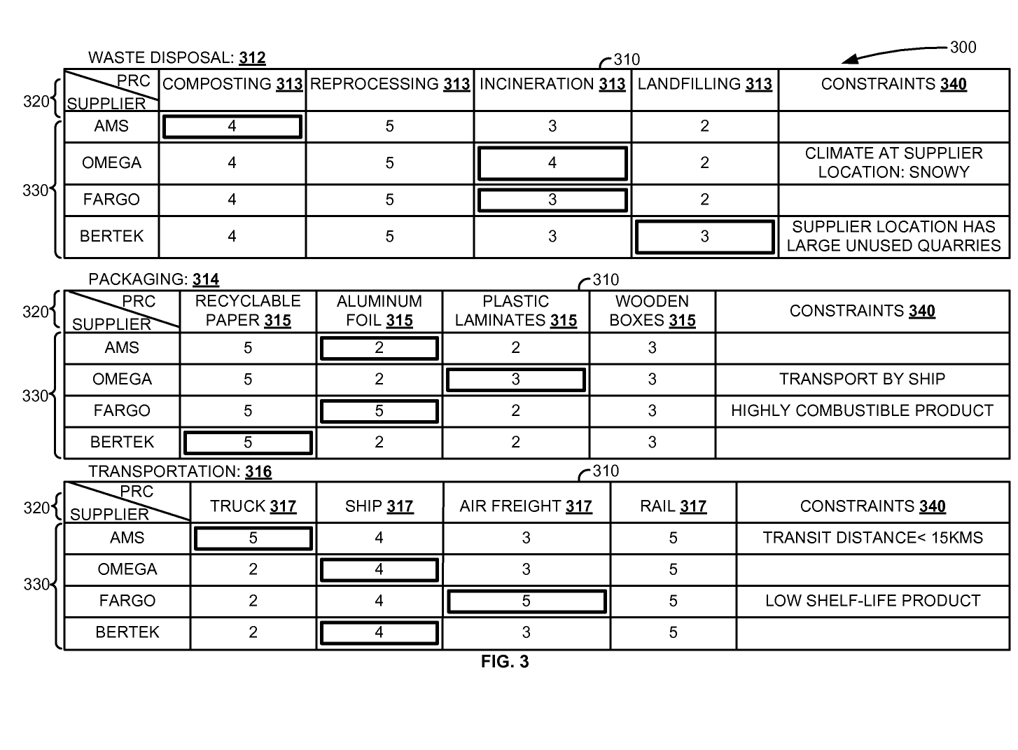

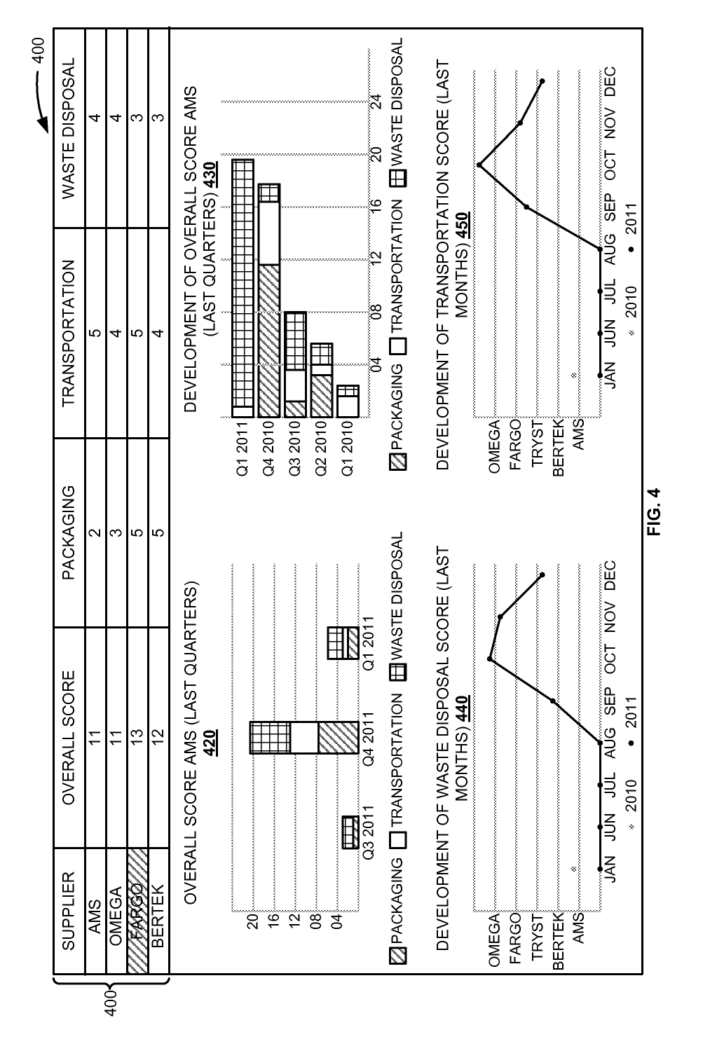

The computer 230 includes a processor that executes software instructions or code stored on a computer readable storage medium to perform the above-illustrated methods. The computer 230 includes a media reader to read the instructions from the computer readable storage medium and store the instructions in storage or in random access memory (RAM). For example, the computer readable storage medium includes executable instructions for performing operations including, but not limited to, configuring one or more criteria relating to a product as green sourcing metrics, defining one or more constraints effecting interdependencies between the green sourcing metrics, customizing the green sourcing metrics based on the one or more constraints, performing green sourcing analysis for the suppliers, and providing a sourcing recommendation. The business modules relating to procurement, sourcing, production, and R&D, among others, may each include a computer (not shown) operating on a set of instructions to perform associated functions. The user interface of the computer 230 is configured to display a dashboard showing results of the supplier evaluation generated in the backend system 210 as will be discussed in more detail later with reference to FIGS. 3 and 4.

According to an aspect, the computer's 230 memory holds a set of criteria relating to a product and/or a supplier of the product that are pre-configured as green sourcing metrics and one or more pre-defined constraints effecting the interdependencies of the green sourcing metrics. The processor then extracts product data 240 relating to the product of each supplier 245, where the product data is composed of one or more attributes i.e., product_related_characteristic. In an example, the attributes composing the product data include, material(s) used for manufacturing the product, design and functionality of the product, extraction and processing of materials, packaging and distribution, manufacturing processes, mode of transport, emission control measures, distance between a supplier site and a procurement site, energy management measures, waste disposal measures, environmental policies, and compliance certificates. The product data may be received from the supplier 245 through a questionnaire or be extracted from product factsheets and supplier factsheets stored in databases within the ERP system 200. In an aspect, the product data may be received from external data sources such as external data feeds, web services, market research data, surveys and statistics. In an example, the external data sources can provide additional product data relating to a supplier such as, the supplier's geographic location, distance from the supplier's warehouse to the purchaser's or customer's site, climatic conditions, weather forecast, etc. The product data may also be collected by manual examination of the product at a procurement site by personnel, machine vision systems, or an automaton. Again, the evaluation data may be manually entered into the backend system 210 or through automated digital means.

The processor upon sensing that at least one attribute composing the product data of a supplier fulfills the pre-defined constraints in the memory, generates a customized set of green sourcing metrics specific to the supplier for evaluation. The term “customized” as used herein refers to adapting the green sourcing metrics according to the one or more predefined criteria. Based on the customized green sourcing metrics, the supplier is evaluated to measure the supplier's competence in adopting sustainable practices. The supplier's measure of competence may be realized as a green score, wherein higher the score, better the competence. In an embodiment, the one or more metrics stored in the memory are classified into different categories such that each of the product_related_characteristics (PRC) falling with a particular category is assigned a score in relation the other PRCs falling within the same category. For example, the one or more metrics may be classified into one of the following categories: Design & Functionality, Extraction & Processing of materials, Manufacturing Processes, Packaging & Distribution, Logistics, and Recycling & Disposal, Supplier demography. A score is then assigned to each of the PRCs within a particular category. For example, each of the PRCs falling within the metric category of Packaging & Distribution, such as aluminum foil, recycled paper, cartons, corrugated boxes, plastic laminates, paper boards, plastic films, plastic crates, glass bottles, tin containers, bamboo baskets, wooden boxes, bubble wraps, blister packs, textile material, jute, etc., is assigned a score. In an embodiment, the score for each PRC is determined based on certain regulatory requirements or sustainable aspects such as reuse, recyclability, ease of disposal, contaminate emissions, carbon emissions, energy recovery, mass and volume, etc. Similarly, for PRCs falling under the metric category Recycling & Disposal, such as composting, reprocessing, incineration, landfilling, etc., a score is assigned based on the environmental impact caused by each of the disposal methods. The processor evaluates the one or more suppliers based on the customized green sourcing metrics and their associated scores. In an embodiment, the processor calculates a green score for each of the suppliers as an aggregate of the scores of the customized green sourcing metrics for each supplier. The processor performs similar steps for several other suppliers and provides a sourcing recommendation based on an analysis of the consolidated green scores of the suppliers. In an aspect, the processor performs an analysis of the suppliers green trend over a period of time. For example, the processor may perform an analysis of a supplier's green scores for a certain number of years. In an embodiment, the processor identifies one or more supplier having a low green score and generates a supplier development plan 250 for the one or more suppliers. The supplier development plan may identify those criteria for which the supplier has scored a low value.

In an embodiment, the green scores for the suppliers and the supplier's green trend analysis are rendered as a graphical representation in a dashboard as shown with reference to FIG. 4. The dashboard is capable of being rendered on a user interface of the computer 330 in the backend system 210 or any other computer on the ERP system 200. In an embodiment, the dashboard may be auto-populated with certain information collected from the various business modules 220, 222, 224, and 225. For example, the procurement module 220 of the ERP system 200 may provide certain information regarding the supplier's demographics such as the supplier's location, distance from supplier's location to product destination, mode of transport, etc. Since the system 200 is integrated in real-time, any updates made to the business modules 220, 222, 224, and 226 or data source systems get reflected instantly at the backend system 210 so that the generated green score dashboard is customized based on the latest available data. For example, the data source system may provide information relating to environmental laws and green standards for a particular territory. Since such laws and regulations are subject to amendments from time to time, the data source system may provide updated information from time to time. Further, the data collection template may be auto-populated with information regarding the minimum number of metrics that need to be applied. For example, the minimum no. of metrics to be applied may be based on a governing law or standard, certification criteria, identified product, or supplier.

FIG. 3 illustrates an exemplary supplier evaluation tool having customized green sourcing metrics, in accordance with an embodiment. In the given example, the supplier evaluation tool 300 is displayed on a graphical user interface of the computer 330. The supplier evaluation tool 300 provides an overview of the green sourcing metrics and their associated attributes involved in arriving at an overall green score for a supplier. In the given example, the supplier evaluation tool is illustrated with reference to three green sourcing metrics only for reasons of brevity and should not be construed as limiting. The supplier evaluation tool 300 includes a metric table 310 for each of the green sourcing metrics 312, 314, and 316 and the associated product_related_characteristics (PRCs) 313, 315, and 317, respectively. The metric tables 310 include a header column 330 representing the suppliers being evaluated and a header row 320 representing the various attributes (PRCs) associated with the corresponding metric 312, 314, or 316. Further, the metric tables 310 include a column 340 representing the Constraints that influence the customization of the green sourcing metrics for a particular supplier. The value provided under a certain column and row indicates the customized score for the PRC represented by that column, for the supplier represented by that row. The scores provided in the metric tables 310 are customized according to the constraints provided in the corresponding Constraints column 340.

In the given example, the scores under each metric table are adapted/adjusted from a base score provided by default for each PRCs. In an embodiment, the base scores under each metric table is automatically populated by the system based on predefined scores stored in the system. The base scores are then automatically adapted from the base scores based on pre-configured settings involving various constraints. For example, the values 2-5 are initially assigned as base scores to each of the PRCs. The default base values are then customized based on the constraints for each of the suppliers. For a PRC that is missing for a certain supplier, a base value of “0” may be assigned. Referring to the metric table 310 for Waste Disposal 312, the value “4” under column “Incineration” and row “Omego” indicates the customized score for the waste disposal method of Incineration for supplier Omego given the constraint of a snowy weather in Omego's geographic location. Due to a snowy weather, more sustainable methods such as Composting may not be feasible while the Incineration method may serve other purposes such as in heating systems. Although the default base score for the PRC: Incineration is “3,” based on pre-defined constraints, a score of “4” is assigned to Incineration such that the disposal method of Incineration is considered on par with composting considering the constraints specific to Omego. Similarly, in the metric table 310 for Packaging 314, the value of “5” under column “Aluminum foil” and row “Fargo” indicates the customized score for packaging using Aluminum foil by Supplier Fargo. Due to the supplied product being highly combustible, more sustainable methods such as recyclable paper or wood may not be fireproof while the use of Aluminum foil as packaging material may serve well to protect the product from fire or oxygen. Accordingly, although the default base score for Aluminum foil is “2,” a customized score of “5” is assigned for Aluminum foil such that Aluminum foil is considered on par with other packaging materials such as recyclable paper considering the constraint specific to Fargo. Similarly, other values in the metric tables 310 are customized and provided for evaluating the suppliers. Based on the customized scores assigned to the PRCs relating to each supplier, in the supplier evaluation tool 300, a green score is evaluated for each supplier. The green scores for all the suppliers are consolidated and provided in a dashboard.

In an embodiment, the green scores for each supplier are calculated as a weighted average, where the weights associated with the metrics such as transport, packaging, waste disposal, etc., are configurable and allow also for a ranking of the screen scores according to the purchaser's needs. For example, more weight may be assigned to green sourcing metrics that represent valued sustainability practices for an organization. That is, an organization can configure the green sourcing metrics within a system to reflect an organization's internal values, priorities, and thresholds with respect to sustainability.

FIG. 4 illustrates a dashboard showing results of green sourcing analysis, in accordance with an embodiment. In the given example, the dashboard 400 is displayed on a graphical user interface of the computer 330. The dashboard 400 includes a summary table 410 and graphical representations 420, 430, 440, and 450. In addition, the dashboard 400 may display information regarding the metrics used for evaluation, the suppliers being evaluated, the products evaluated, metric-wise green score, overall green score, ranked list of suppliers, classified list of suppliers, sourcing recommendation, etc. The summary table 410 projects a summary of the green scores for each of the suppliers, evaluated using the supplier evaluation tool discussed with reference to FIG. 3. The graphical representations 420, 430, 440, and 450 include charts and plots generated based on the green sourcing analysis for the suppliers. In the given example, graph 420 represents the overall green score for supplier AMS over the last three quarters and graph 430 represents the development of the overall green score for supplier AMS over the last quarters. Plot 440 represents an overall metric-wise green trend for the metric Waste disposal for the last twelve months. Plot 450 represents a metric-wise green trend for the metric Transportation for the last twelve months. The graphs and plots are provided for by way of example and not by way of limitation. Other representations of data resulting from the green sourcing analysis that can be envisaged from the described methods and systems may be rendered on the dashboard. For example, the dashboard 400 can be configured to display a cost comparison for sourcing the product from different suppliers and may further be configured to provide a proposal for a supplier replacement based on weighted cost deviations in the cost comparison.

The dashboard may also provide a sourcing recommendation including identifying a supplier with the highest green score as an alternate sourcing option, identifying a supplier with a low green score as a candidate for supplier development plan, identifying a supplier with a high green score as a replacement for another supplier with a low green score, etc. The recommendation may be provided in any visual or audio forms including but not limited to highlighting, text effects, color codes, audio alerts, pop-ups, etc. Based on the sourcing recommendation a sourcing decision may be taken by the sourcing personnel or an automated system. For example, the sourcing personnel may, based on the results displayed on the dashboard, opt to source goods from a supplier with a better green score then the supplier currently engaged with. Similarly, a supplier with a low green score may be enlisted for a development plan in which certain green measures are recommended to the supplier to adopt. The suppliers under the development plan may be re-evaluated after a certain period of time to measure their improved green scores.

In an example scenario, green sourcing analysis is performed on three suppliers and a sourcing recommendation is provided based on the analysis. Assuming that all three suppliers A, B, and C are supplying the same product, one or more criteria are configured as green sourcing metrics. In this example, the product is a chemical compound. The green sourcing metrics relating to the product include manufacturing methods, material used for manufacturing, waste disposal measures, emission control measures, mode of transportation, packaging material used. The product data relating to the chemical compound supplied by supplier A is automatically extracted from the product factsheet. The product data relating to the chemical compound supplied by supplier B is automatically extracted from supplier factsheets. The product data relating to the chemical compound supplied by supplier C is (if applicable) automatically extracted from a filled-in Questionnaire sent along with an RFx. In addition, other product or supplier related data such as the supplier's location, climatic conditions, governing standards and laws pertaining to supplier's location etc., are received through external data source systems in real-time. From the product data for supplier A, it is determined that supplier A transports the chemical compound by ship, uses catalytic reduction for emission control, and uses plastic laminates for packing the product; Supplier B transports the chemical compound by rail, uses zero-emission manufacturing material, and uses plastic laminates for packing the product, and uses windmills as source of power; Supplier C transports the chemical compound by truck, does not use any emission control measures, and packs the product using recyclable paper.

The computer implemented supplier evaluation process initiates with assigning a default base score to each PRC of the one or more metrics and storing the default base scores in the memory of the computer. The processor of the computer generates a customized set of green sourcing metrics based on the pre-configured constraints stored in the memory and the product data of each supplier A, B, and C. Based on the product data, the processor determines whether a constraint stored in the memory is met. In this example, the one or more constraints stored in the memory that are fulfilled are: waste disposal measures Vs zero by-product manufacturing material, packaging material Vs mode of transport, carbon emission control Vs low carbon emission manufacturing material, source of energy Vs Geographic location. Based on the fulfilled constraints the processor customizes the green sourcing metrics by assigning customized scores to the PRCs under each metric according to the conditions defined by the constraint. As shown in Table 1 below a customized score of “4” is assigned to Plastic Laminate packaging material for Supplier A instead of a default base score of “2” due to Supplier A transporting the chemical compound by ship. Supplier A's transport by ship invokes the constraint relating to packaging material Vs mode of transport, which is configured considering that transport by ship requires packaging using water-proof material for practical reasons. According to the constraint, packaging using plastic laminates is scored equal to packaging by ceramic or recyclable paper. Similarly, Supplier C's usage of thermal energy source is scored equal to wind or solar energy source as Supplier C uses Vapor recovery process as an emission control measure provides the resource needed for driving a thermal power plant. Accordingly, Supplier C's usage of Thermal energy source is assigned a customized score of “6” instead of the default score of “4.” Although Supplier B does not employ any direct emission control measures, a customized score of “6” is assigned for the metric-Emission control due to Supplier B's constraint of using Zero-emission manufacturing material.

TABLE 1

| | | Base | Customized scores | | |
|---|---|---|---|---|---|
| Metric | PRC | score | Supplier A | Supplier B | Supplier C |
| Con- | | | Transport | Zero-emission | |
| straints | | | by ship | manufacturing | |
| | | | | material | |
| Emission | Vapor | 6 | — | —6* | 6 |
| control | recovery | | | | |
| | system | | | | |
| | Electrostatic | 2 | — | — | — |
| | precipitators | | | | |
| | Catalytic | 4 | 4 | — | — |
| | reduction | | | | |
| Transport | Truck | 2 | — | — | 2 |
| | Rail | 4 | — | 4 | — |
| | Ship | 6 | 6 | — | — |
| Packaging | Plastic | 2 | 4* | 2 | 2 |
| | laminate | | | | |
| | Recyclable | 6 | — | — | 6 |
| | paper | | | | |
| | Ceramic | 4 | — | — | 6 |
| Energy | Thermal | 4 | — | — | 6* |
| Source | Wind | 6 | — | 6 | — |
| | Solar | 5 | — | — | — |

| | | | |
|---|---|---|---|
| Overall green score | 14 | 18 | 28 |

Based on the customized metrics an overall green score is calculated for each of the suppliers. A sourcing recommendation to opt for Supplier C to source the chemical compound is provided. In an example, the sourcing recommendation may be provided based on a cost associated with sourcing the product with each of the suppliers and the overall green score for each of the suppliers.

Some embodiments of the invention may include the above-described methods being written as one or more software components. These components, and the functionality associated with each, may be used by client, server, distributed, or peer computer systems. These components may be written in a computer language corresponding to one or more programming languages such as, functional, declarative, procedural, object-oriented, lower level languages and the like. They may be linked to other components via various application programming interfaces and then compiled into one complete application for a server or a client. Alternatively, the components maybe implemented in server and client applications. Further, these components may be linked together via various distributed programming protocols. Some example embodiments of the invention may include remote procedure calls being used to implement one or more of these components across a distributed programming environment. For example, a logic level may reside on a first computer system that is remotely located from a second computer system containing an interface level (e.g., a graphical user interface). These first and second computer systems can be configured in a server-client, peer-to-peer, or some other configuration. The clients can vary in complexity from mobile and handheld devices, to thin clients and on to thick clients or even other servers.

The above-illustrated software components are tangibly stored on a computer readable storage medium as instructions. The term “computer readable storage medium” should be taken to include a single medium or multiple media that stores one or more sets of instructions. The term “computer readable storage medium” should be taken to include any physical article that is capable of undergoing a set of physical changes to physically store, encode, or otherwise carry a set of instructions for execution by a computer system which causes the computer system to perform any of the methods or process steps described, represented, or illustrated herein. Examples of computer readable storage media include, but are not limited to: magnetic media, such as hard disks, floppy disks, and magnetic tape; optical media such as CD-ROMs, DVDs and holographic devices; magneto-optical media; and hardware devices that are specially configured to store and execute, such as application-specific integrated circuits (“ASICs”), programmable logic devices (“PLDs”) and ROM and RAM devices. Examples of computer readable instructions include machine code, such as produced by a compiler, and files containing higher-level code that are executed by a computer using an interpreter. For example, an embodiment of the invention may be implemented using Java, C++, or other object-oriented programming language and development tools. Another embodiment of the invention may be implemented in hard-wired circuitry in place of, or in combination with machine readable software instructions.

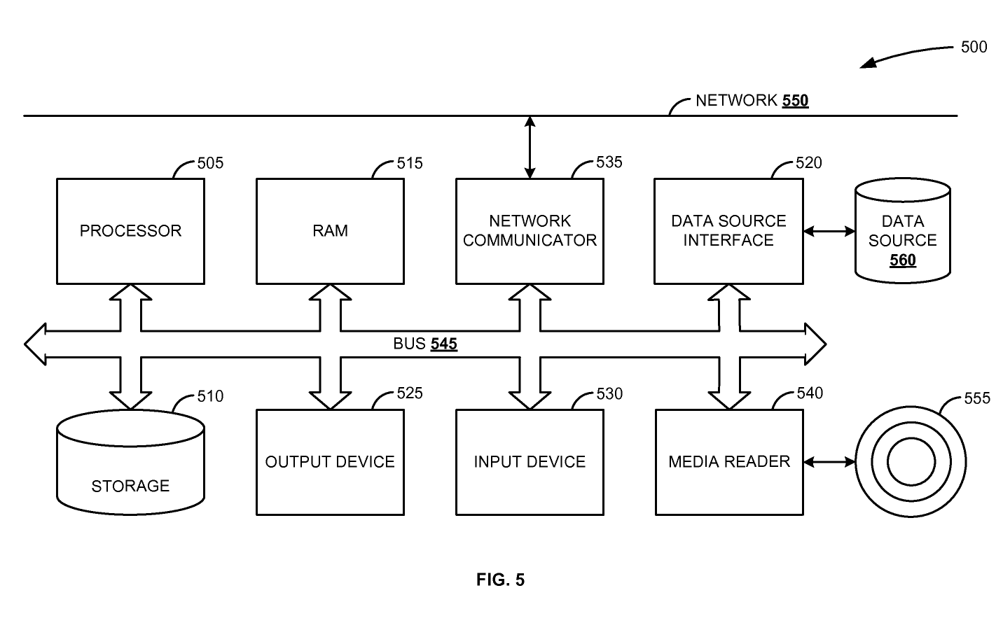

FIG. 5 is a block diagram of an exemplary computer system 500. The computer system 500 includes a processor 505 that executes software instructions or code stored on a computer readable storage medium 555 to perform the above-illustrated methods of the invention. The computer system 500 includes a media reader 540 to read the instructions from the computer readable storage medium 555 and store the instructions in storage 510 or in random access memory (RAM) 515. The storage 510 provides a large space for keeping static data where at least some instructions could be stored for later execution. The stored instructions may be further compiled to generate other representations of the instructions and dynamically stored in the RAM 515. The processor 505 reads instructions from the RAM 515 and performs actions as instructed. According to one embodiment of the invention, the computer system 500 further includes an output device 525 (e.g., a display) to provide at least some of the results of the execution as output including, but not limited to, visual information to users and an input device 530 to provide a user or another device with means for entering data and/or otherwise interact with the computer system 500. Each of these output devices 525 and input devices 530 could be joined by one or more additional peripherals to further expand the capabilities of the computer system 500. A network communicator 535 may be provided to connect the computer system 500 to a network 550 and in turn to other devices connected to the network 550 including other clients, servers, data stores, and interfaces, for instance. The modules of the computer system 500 are interconnected via a bus 545. Computer system 500 includes a data source interface 520 to access data source 560. The data source 560 can be accessed via one or more abstraction layers implemented in hardware or software. For example, the data source 560 may be accessed by network 550. In some embodiments the data source 560 may be accessed via an abstraction layer, such as, a semantic layer.

A data source is an information resource. Data sources include sources of data that enable data storage and retrieval. Data sources may include databases, such as, relational, transactional, hierarchical, multi-dimensional (e.g., OLAP), object oriented databases, and the like. Further data sources include tabular data (e.g., spreadsheets, delimited text files), data tagged with a markup language (e.g., XML data), transactional data, unstructured data (e.g., text files, screen scrapings), hierarchical data (e.g., data in a file system, XML data), files, a plurality of reports, and any other data source accessible through an established protocol, such as, Open DataBase Connectivity (ODBC), produced by an underlying software system (e.g., ERP system), and the like. Data sources may also include a data source where the data is not tangibly stored or otherwise ephemeral such as data streams, broadcast data, and the like. These data sources can include associated data foundations, semantic layers, management systems, security systems and so on.

In the above description, numerous specific details are set forth to provide a thorough understanding of embodiments of the invention. One skilled in the relevant art will recognize, however that the invention can be practiced without one or more of the specific details or with other methods, components, techniques, etc. In other instances, well-known operations or structures are not shown or described in details to avoid obscuring aspects of the invention.

Although the processes illustrated and described herein include series of steps, it will be appreciated that the different embodiments of the present invention are not limited by the illustrated ordering of steps, as some steps may occur in different orders, some concurrently with other steps apart from that shown and described herein. In addition, not all illustrated steps may be required to implement a methodology in accordance with the present invention. Moreover, it will be appreciated that the processes may be implemented in association with the apparatus and systems illustrated and described herein as well as in association with other systems not illustrated.

The above descriptions and illustrations of embodiments of the invention, including what is described in the Abstract, is not intended to be exhaustive or to limit the invention to the precise forms disclosed. While specific embodiments of, and examples for, the invention are described herein for illustrative purposes, various equivalent modifications are possible within the scope of the invention, as those skilled in the relevant art will recognize. These modifications can be made to the invention in light of the above detailed description. Rather, the scope of the invention is to be determined by the following claims, which are to be interpreted in accordance with established doctrines of claim construction.

What is claimed is:

1. A computer implemented method, in a sourcing system, the method comprising:
configuring one or more criteria relating to a product as green sourcing metrics;
defining one or more constraints effecting interdependencies between the green sourcing metrics;
invoking product data relating to one or more suppliers of the product;
determining that at least one of the one or more constraints is fulfilled based on the product data;
customizing, by the computer, the green sourcing metrics based on the at least one of the one or more constraints that is fulfilled; and
performing green sourcing analysis for the one or more suppliers of the product based on the customized green sourcing metrics.

2. The method of claim 1, wherein configuring the one or more criteria relating to the product as green sourcing metrics comprises configuring various modes of manufacturing, shipping, and packaging the product as green sourcing metrics.

3. The method of claim 1, wherein defining the one or more constraints effecting interdependencies between the green sourcing metrics comprises defining override conditions for at least one of the green sourcing metrics in relation to at least one other of the green sourcing metrics.

4. The method of claim 1, wherein invoking the product data relating to the one or more suppliers supplying the product comprises extracting the product data from at least one of: supplier factsheets, product factsheets, surveys, questionnaires, integrated ERP systems, web services, and external data feeds.

5. The method of claim 1, wherein customizing the green sourcing metrics comprises selecting a set of metrics of the green sourcing metrics over another set of metrics of the green sourcing metrics based on the at least one of the one or more constraints that is fulfilled.

6. The method of claim 1, wherein performing the green sourcing analysis comprises identifying at least one of the one or more suppliers as a green supplier based on the green sourcing analysis.

7. The method of claim 6, wherein performing the green sourcing analysis comprises:
calculating a cost associated with sourcing the product from the green supplier; and
providing a comparison of the calculated cost with a cost associated with sourcing the product from at least one other of the one or more suppliers.

8. The method of claim 1, wherein performing the green sourcing analysis for the one or more suppliers comprises:
determining that one or more attributes composing the product data matches at least one of the customized green sourcing metrics; and
providing a green sourcing score for the one or more suppliers based on the one or more attributes matching at least one of the customized green sourcing metrics.

9. The method of claim 1, wherein performing the green sourcing analysis for the one or more suppliers further comprises assigning weights to the customized green sourcing metrics.

10. The method of claim 1, wherein the product data comprises at least one of: material(s) used for manufacturing the product, material(s) used for packing the product, method of manufacturing the product, mode of transport used for shipping the product, distance between a supplier site and a procurement site, energy management measures, waste disposal measures, environmental policies, and compliance certificates.

11. A computer implemented method, in a sourcing system, the method comprising:
configuring one or more criteria relating to a product as green sourcing metrics;
defining one or more constraints effecting interdependencies between the green sourcing metrics;
invoking product data relating to one or more suppliers of the product;
determining that at least one of the one or more constraints is fulfilled based on the product data;
customizing, by the computer, the green sourcing metrics based on the at least one of the one or more constraints that is fulfilled;
performing, by the computer, green sourcing analysis for the one or more suppliers of the product based on the customized green sourcing metrics; and
providing, by the computer, a sourcing recommendation based on the green sourcing analysis for the one or more suppliers.

12. The method of claim 11, wherein providing, by the computer, the sourcing recommendation based on the green sourcing analysis for the one or more suppliers comprises identifying at least one supplier of the one or more suppliers as an alternate sourcing option.

13. An article of manufacture, comprising:
a computer readable storage medium having instructions which when executed by a computer causes the computer to:
configure one or more criteria relating to a product as green sourcing metrics;
define one or more constraints effecting interdependencies between the green sourcing metrics;
invoke product data relating to one or more suppliers of the product;
determine that at least one of the one or more constraints is fulfilled based on the product data;
customize the green sourcing metrics based on the at least one of the one or more constraints that is fulfilled; and
perform green sourcing analysis for the one or more suppliers of the product based on the customized green sourcing metrics.

14. The article of manufacture in claim 13, further comprises instructions to provide a sourcing recommendation based on the green sourcing analysis for the one or more suppliers.

15. The article of manufacture in claim 13, wherein the one or more criteria relating to the product includes at least one of material(s) used for manufacturing the product, material(s) used for packing the product, mode of transport used for shipping the product, distance between a supplier site and a procurement site, energy management measures, waste disposal measures, environmental policies, and compliance certificates.

16. An integrated system operating in a communication network, comprising:
at least one data source system;
a data repository to store data collected from the at least one data source system; and
a computer comprising a memory to store a program code, and a processor to execute the program code to:
configure one or more criteria relating to a product as green sourcing metrics;
define one or more constraints effecting interdependencies between the green sourcing metrics;
invoke product data relating to one or more suppliers of the product;
determine that at least one of the one or more constraints is fulfilled based on the product data;
customize the green sourcing metrics based on the at least one of the one or more constraints that is fulfilled; and
perform green sourcing analysis for the one or more suppliers of the product based on the customized green sourcing metrics.

17. The system of claim 16, wherein the one or more suppliers is an entity vending the product.

18. The system of claim 16, wherein the product includes at least one of a service, a solution, and an article of manufacture.

19. The system of claim 16, wherein the at least one data source system includes at least one of a web service, a data warehouse, an integrated ERP system, and external feed from suppliers.

20. The system of claim 16, wherein the integrated sourcing system is an Enterprise Resource Planning (ERP) system.
